(19) United States
(12) Patent Application Publication
(10) Pub. No.: US 2024/0213824 A1
(43) Pub. Date: Jun. 27, 2024

(54) STATOR, MOTOR AND PUMP DEVICE

(71) Applicant: NIDEC INSTRUMENTS CORPORATION, Nagano (JP)

(72) Inventor: Kazuma YAMAMOTO, Nagano (JP)

(73) Assignee: NIDEC INSTRUMENTS CORPORATION, Nagano (JP)

(21) Appl. No.: 18/542,775

(22) Filed: Dec. 18, 2023

(30) Foreign Application Priority Data
Dec. 27, 2022 (JP) 2022-209698

(51) Int. Cl. H02K 1/14; H02K 1/2706; H02K 5/10

(52) U.S. Cl. CPC H02K 1/148; H02K 1/2706; H02K 5/10

(57) ABSTRACT

A stator includes a stator core comprised of a plurality of divided cores which are disposed in a ring shape, and a resin sealing member which covers the stator core. The resin sealing member is provided with a first partition part which covers the stator core from one side in an axial line direction along a center axial line of the stator core, the first partition part is formed with a gate mark, and the gate mark is formed at all positions between the divided cores adjacent to each other when viewed from the one side in the axial line direction.

### CROSS REFERENCE TO RELATED APPLICATION

The present invention claims priority under 35 U.S.C. § 119 to Japanese Application No. 2022-209698 filed Dec. 27, 2022, the entire content of which is incorporated herein by reference.

### TECHNICAL FIELD

At least an embodiment of the present invention may relate to a stator, a motor and a pump device.

### BACKGROUND

A stator in which a plurality of stator cores is covered by a resin sealing member is described in Japanese Patent Laid-Open No. 2021-134769 (Patent Literature 1). The stator described in the patent literature includes a stator core in which a plurality of salient poles is disposed in a ring shape and a resin sealing member which covers the stator core. The resin sealing member is provided with a circular cone-shaped end face which is formed with a gate mark on one side in an axial line direction. The gate mark is provided at one position.

In the technique described in Patent Literature 1, when the stator core is to be covered by a resin sealing member, the stator core is disposed in an inside of a metal mold for resin molding, and resin flows into the inside of the metal mold through a gate arranged on one side with respect to the stator core. As a result, the stator core is covered by a resin sealing member to structure a stator. In this case, one gate mark is formed on an end face of the resin sealing member.

The resin which flows into the metal mold flows into the metal mold through a gate provided at one position and thus, the resin is not uniformly filled in the metal mold. Therefore, the stator core may be moved from a predetermined position in an inside of the metal mold due to the resin flowing into the metal mold. Further, due to a position of a gate arranged with respect to the stator core, the stator core may be also moved from a predetermined position in the inside of the metal mold by the resin flowing into the metal mold. In this case, a stator core of the structured stator is displaced from an appropriate position with respect to the resin sealing member and thus, when the stator is used for a motor, a desired performance cannot be attained.

### SUMMARY

At least an embodiment of the present invention may advantageously provide a stator in which a stator core is covered with respect to a resin sealing member at an appropriate position. Further, at least an embodiment of the present invention may advantageously provide a motor and a pump device which use the stator.

According to at least an embodiment of the present invention, there may be provided a stator including a stator core structured of a plurality of divided cores which are disposed in a ring shape and a resin sealing member which covers the stator core. The resin sealing member is provided with a first partition part which covers the stator core from one side in an axial line direction along a center axial line of the stator core, the first partition part is formed with a gate mark, and the gate mark is formed at all positions between the divided cores adjacent to each other when viewed from the one side in the axial line direction.

According to at least an embodiment of the present invention, the gate mark is, when viewed in the axial line direction of the center axial line, formed at all positions between the adjacent divided cores. Therefore, when the stator core is arranged in an inside of the metal mold and the stator core is to be covered by the resin sealing member, resin uniformly flows into the inside of the metal mold between the adjacent divided cores. In this case, the resin flows between the divided cores toward a bottom part of the metal mold and is accumulated from the bottom part. Therefore, when the stator core is to be covered with the resin sealing member, the stator core can be inhibited from moving from a predetermined position in the inside of the metal mold. As a result, the stator can be obtained in which the stator core is covered at an appropriate position by the resin sealing member.

In the present invention, the stator includes a coil which is wound around the divided core, the divided core is provided with an outer side arc part formed in an arc shape and a salient pole part which is protruded from the outer side arc part toward an inner side in a radial direction of the stator core, the coil is wound around the salient pole part, and the gate mark is formed in a first region in the radial direction where the coil is wound when viewed from the one side in the axial line direction. In this case, in the present invention, the gate mark is formed in a second region on an inner side in the radial direction with respect to a center part of the first region when viewed from the one side in the axial line direction. According to this structure, when the stator core is to be covered by the resin sealing member, the stator core can be further inhibited from moving from a predetermined position in the inside of the metal mold.

The stator in accordance with an embodiment of the present invention may be used in a motor. In this case, the motor includes the above-mentioned stator and a rotor which is disposed on an inner side with respect to the stator core and is rotated around the center axial line.

The motor in accordance with an embodiment of the present invention may be used in a pump device. In this case, the pump device includes the above-mentioned motor, a case which covers the resin sealing member from the one side and forms a pump chamber between the resin sealing member and the case, and an impeller which is disposed in the pump chamber and is rotated together with the rotor.

### Effects of the Invention

In the present invention, the gate mark is, when viewed in the axial line direction of the center axial line, formed between each of the adjacent divided cores. Therefore, when the stator core is arranged in an inside of the metal mold and the stator core is to be covered with the resin sealing member, resin uniformly flows into the inside of the metal mold between the adjacent divided cores and thus, the stator core can be inhibited from moving from a predetermined position in the inside of the metal mold. As a result, the stator can be obtained in which the stator core is covered at an appropriate position by the resin sealing member.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing a pump device and a motor in accordance with an embodiment of the present invention.

FIG. 2 is a longitudinal cross-sectional view showing the pump device and the motor shown in FIG. 1.

FIG. 3 is a perspective view showing a stator core, an insulator and a coil.

FIG. 4 is a perspective view showing a stator core.

FIG. 5 is a view showing a stator.

FIG. 6 is a view showing a relationship between gate marks and a stator core.

FIG. 7 is an enlarged view showing a portion which is shown by the “A” in FIG. 6.

FIG. 8 is a schematic view showing a metal mold for performing insert molding of a resin sealing member.

### DETAILED DESCRIPTION

A motor and a pump device in accordance with an embodiment of the present invention will be described below with reference to the accompanying drawings. In the following descriptions, a motor axial line “L” direction means an axial line direction along a motor axial line “L”, a radial direction regarding an inner side in the radial direction and an outer side in the radial direction means a radial direction with the motor axial line “L” as a center, and a circumferential direction means a rotation direction with the motor axial line “L” as a center.

### Entire Structure

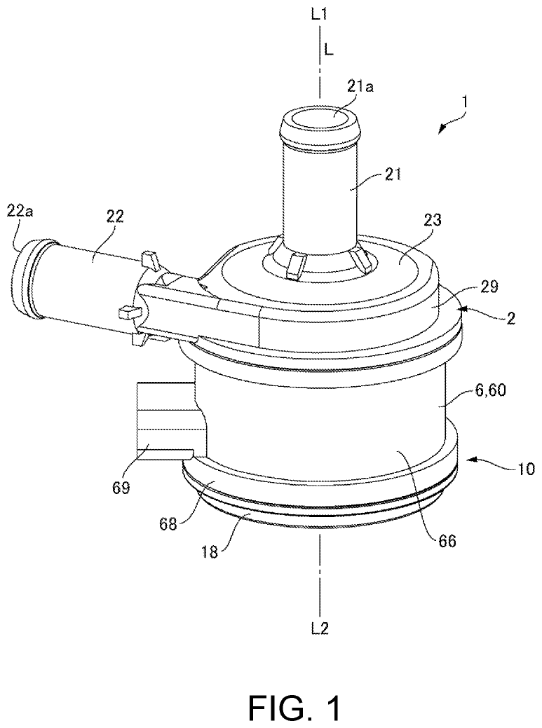

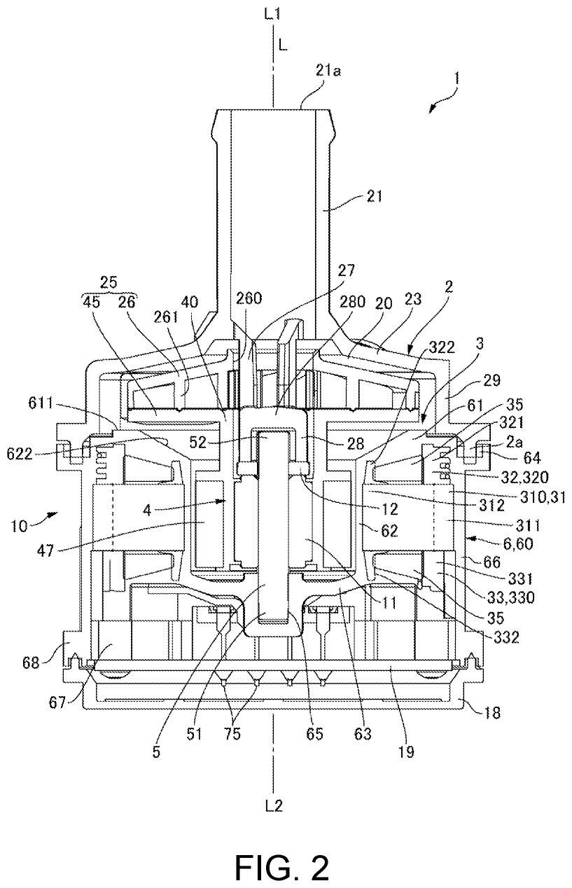

FIG. 1 is a perspective view showing a motor 10 and a pump device 1 to which a stator in accordance with an embodiment of the present invention is applied. FIG. 2 is a longitudinal cross-sectional view showing the pump device 1 and the motor 10 shown in FIG. 1. In FIGS. 1 and 2, the pump device 1 includes a case 2, a motor 10 disposed the other side “L2” in a motor axial line “L” direction with respect to the case 2, and an impeller 25 disposed in a pump chamber 20 in an inside of the case 2. The impeller 25 is rotationally driven by the motor 10 around the motor axial line “L”. The motor 10 includes a stator 3 in a cylindrical tube shape, a rotor 4 disposed on an inner side with respect to the stator 3, and a support shaft 5 in a round bar shape which rotatably supports the rotor 4. The support shaft 5 is made of metal or ceramic. In the pump device 1 in this embodiment, fluid is liquid, and the pump device 1 is used as an on-vehicle pump where environment temperature and fluid temperature are easily changed.

The case 2 is structured of a side wall 23 on one side “L1” in the motor axial line “L” direction of the pump device 1 and a side wall 29 which is extended in a circumferential direction. The case 2 is provided with a suction pipe 21 extended along the motor axial line “L” and a discharge pipe 22 which is extended in a direction perpendicular to the motor axial line “L”. The suction pipe 21 is provided with a suction port 21a. The discharge pipe 22 is provided with a discharge port 22a. The suction pipe 21 is concentrically provided with the motor axial line “L”.

The stator 3 includes a stator core 31, insulators 32 and 33 which are held by the stator core 31, and a coil 35 which is wound around the stator core 31 through the insulators 32 and 33. Further, the stator 3 includes a housing 6 made of resin which covers the stator core 31, the insulators 32 and 33 and the coil 35.

The rotor 4 includes a cylindrical tube part 40 which is extended in the motor axial line “L” direction from a position facing the stator 3 on an inner side in a radial direction to the pump chamber 20. The cylindrical tube part 40 is opened in the pump chamber 20. An outer peripheral face of the cylindrical tube part 40 holds a magnet 47 in a cylindrical tube shape which faces the stator 3 on an inner side in the radial direction. The magnet 47 is, for example, a neodymium bond magnet.

An end part of the cylindrical tube part 40 on one side “L1” in the motor axial line “L” direction is formed with a flange part 45 in a circular plate shape. A circular plate 26 is connected with the flange part 45 from one side “L1” in the motor axial line “L” direction. A center of the circular plate 26 is formed with a center hole 260. A face of the circular plate 26 facing the flange part 45 is formed with a plurality of blade parts 261 which are extended from a periphery of the center hole 260 to an outer side in the radial direction while curving in a circular arc shape at equal angular intervals. The circular plate 26 is fixed to the flange part 45 through the blade parts 261. Therefore, the impeller 25 which is connected with the cylindrical tube part 40 of the rotor 4 is structured of the flange part 45 and the circular plate 26. In this embodiment, the circular plate 26 is inclined so that its outer side in the radial direction approaches the flange part 45 with respect to its inner side in the radial direction.

A radial bearing 11 in a cylindrical tube shape is held on an inner side in the radial direction of the cylindrical tube part 40. The rotor 4 is rotatably supported by the support shaft 5 through the radial bearing 11. A first end part 51 of the support shaft 5 on the other side “L2” in the motor axial line “L” direction is held by a shaft hole 65 formed in a bottom wall 63 of the housing 6. The case 2 is formed with a receiving part 280, which faces a second end part 52 on the pump chamber 20 side of the support shaft 5 from a side of the pump chamber 20, for restricting a movable range of the support shaft 5 to a side of the pump chamber 20. The case 2 is provided with a support part 27 which is extended from an inner peripheral face of the suction pipe 21 to a side of the motor 10. An end part of the support part 27 is formed with a tube part 28 on an inner side of which the support shaft 5 is located. The receiving part 280 is structured by a bottom part of the tube part 28 on one side “L1” in the motor axial line “L” direction. The second end part 52 of the support shaft 5 is attached with a thrust bearing 12 in a circular ring shape. The thrust bearing 12 is disposed between the radial bearing 11 and the tube part 28. In this embodiment, at least a part of each of the first end part 51 and the shaft hole 65 is formed in a “D”-shaped cross section, and the second end part 52 of the support shaft 5 and a hole of the thrust bearing 12 are formed in a “D”-shaped cross section. Therefore, turning of the support shaft 5 and the thrust bearing 12 is prevented.

### Detailed Structure of Stator

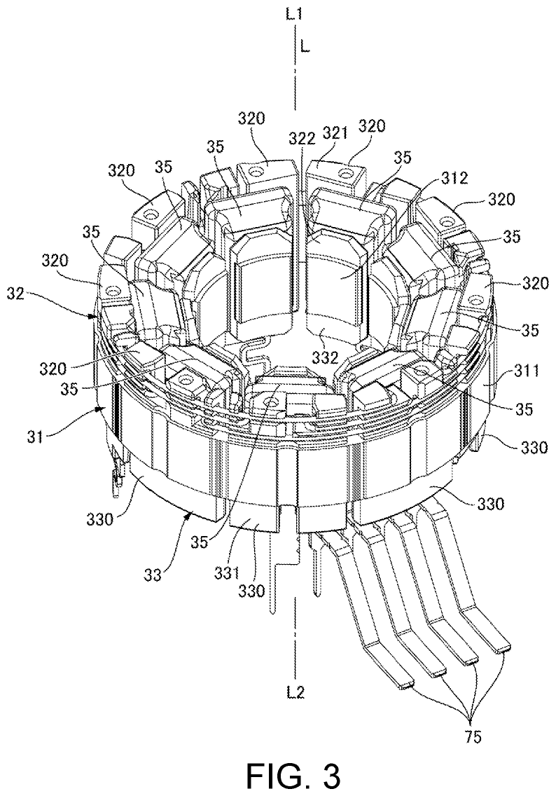

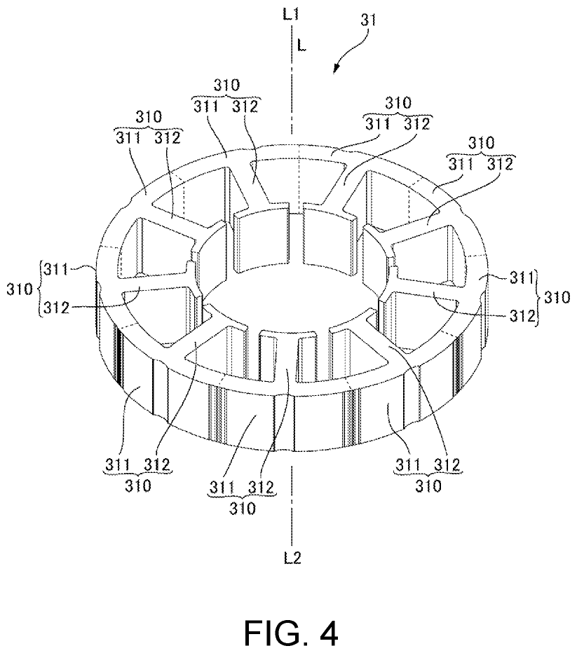

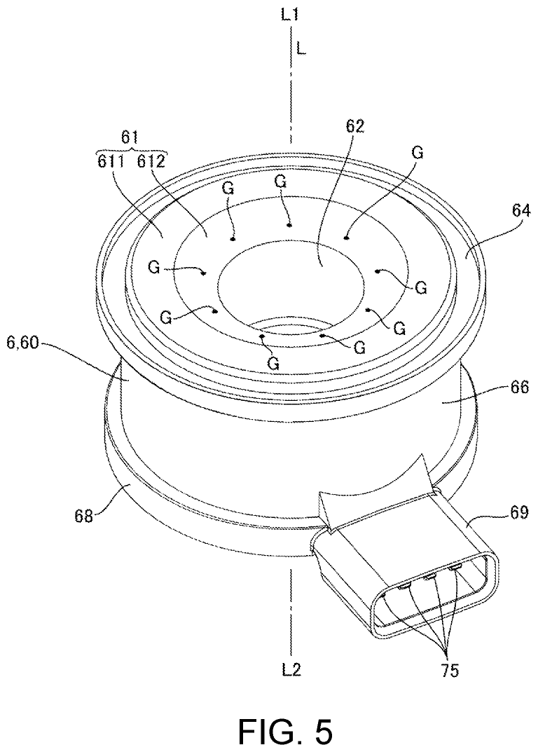

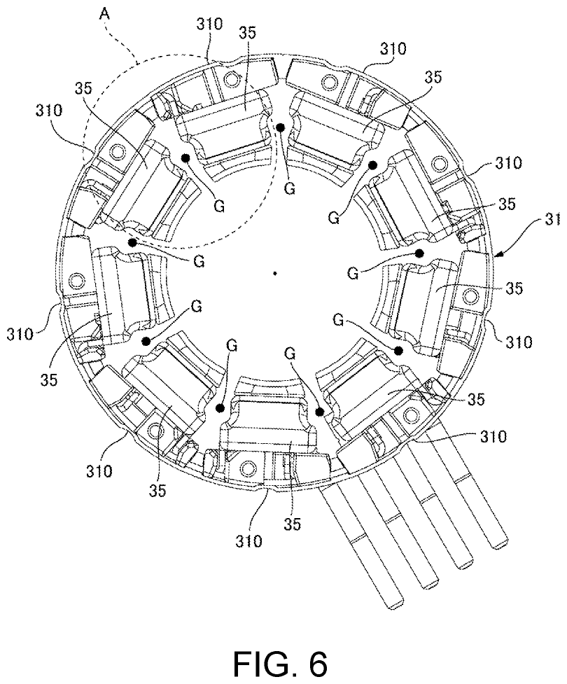

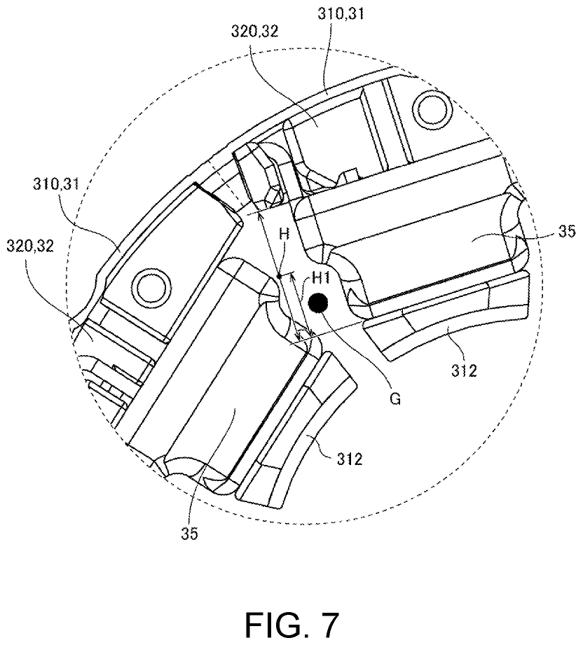

FIG. 3 is a perspective view showing the stator core, the insulators and the coil shown in FIG. 2. FIG. 4 is a perspective view showing the stator core. FIG. 5 is a view showing the stator. FIG. 6 is a view showing a relationship between gate marks and the stator core. FIG. 7 is an enlarged view showing a portion which is shown by the “A” in FIG. 6. In FIGS. 6 and 7, the resin sealing member is not shown except a gate mark.

As shown in FIG. 4, the stator core 31 is structured so that a plurality of divided cores 310 is disposed in a ring shape. A center axial line of the stator core 31 is the motor axial line “L”. In other words, a direction along the center axial line of the stator core 31 is the motor axial line “L” direction. In this embodiment, nine divided cores 310 are disposed. The divided core 310 is provided with an outer side arc part 311 formed in an arc shape and a salient pole part 312 which is protruded from the outer side arc part 311 toward an inner side in the radial direction of the stator core 31. The salient pole part 312 is disposed at a constant pitch in a circumferential direction. The divided core 310 is a laminated core which is formed by laminating thin magnetic plates made of magnetic material.

As shown in FIG. 3, the insulators 32 and 33 are respectively overlapped with the stator core 31 from both sides in the motor axial line “L” direction and respectively cover a plurality of the salient pole parts 312. In this embodiment, the insulators 32 and 33 are respectively structured of a plurality of divided insulators 320 and 330 which are divided corresponding to each of a plurality of the salient pole parts 312. A plurality of the divided insulators 320 and 330 is provided with outer peripheral side portions 321 and 331 which are overlapped with the outer side arc part 311 of the stator core 31 in the motor axial line “L” direction, inner peripheral side portions 322 and 332 which are protruded in the motor axial line “L” direction at an end part of the salient pole part 312 on an inner side in the radial direction, and tube part forming portions (not shown) which connect the outer peripheral side portions 321 and 331 with the inner peripheral side portions 322 and 332. The coil 35 is wound around the salient pole part 312 through the tube part forming portions. The motor 10 is a three-phase motor. Therefore, a plurality of the coils 35 includes a U-phase coil, a V-phase coil and a W-phase coil.

As shown in FIG. 2, the housing 6 covers the stator core 31, the insulators 32 and 33 and the coil 35. In this specification, the stator core 31, the insulators 32 and 33 and the coil 35 are collectively referred to as the “stator core 31 and the like”. As shown in FIGS. 2 and 5, the housing 6 is provided with a first partition part 61 which covers the stator core 31 and the like from one side “L1”, a second partition part 62 which exists between the stator core and the like and the magnet 47, and a body part 66 in a cylindrical tube shape which covers the stator core 31 and the like from an outer side in the radial direction. Therefore, the housing 6 is a resin sealing member 60 which covers the stator core 31 and the like from both sides in the radial direction and from both sides in the motor axial line “L” direction. The resin sealing member 60 is a resin portion which is structured by insert molding the stator core 31 and the like with polyphenylene sulfide (PPS) or the like.

As shown in FIG. 5, the first partition part 61 is provided with a flat face part 611 in a ring shape in its outer peripheral portion and an inclined part 612 in a ring shape on its inner side of the flat face part 611. The inclined part 612 is inclined to the other side “L2” toward its center. An outer peripheral side of the first partition part 61 is provided with a ring-shaped groove 64. As shown in FIG. 2, a protruding part 2a which is protruded from an outer peripheral side portion of the case 2 to the other side “L2” is inserted into the ring-shaped groove 64. The case 2 is fixed to the housing 6 by welding the protruding part 2a to the ring-shaped groove 64.

The second partition part 62 forms a ring-shaped tube part and accommodates the rotor 4 in its inside. The body part 66 is formed with a connector housing 69 in a tube shape. End parts of connector terminals 75 are located on an inner side of the connector housing 69.

As shown in FIG. 2, an end part 67 on the other side “L2” of the housing 6 is disposed with a board 19 on which a circuit for controlling power feeding to the coil 35 and the like are provided. The board 19 is a rigid board such as a glass epoxy substrate and is formed in a flat face shape. The board 19 is disposed at the end part 67 on the other side “L2” of the housing 6 and is fixed to the housing 6 by a screw or the like. The board 19 is covered by a cover 18 which is fixed to a flange part 68 provided at an end portion on the other side “L2” of the housing 6. The board 19 is electrically connected with end parts of a wire of the coil 35 and the connector terminals 75. When a signal is inputted into the board 19 from the outside through the connector terminals 75, the rotor 4 is rotated around the motor axial line “L”. As a result, the impeller 25 is rotated in the inside of the pump chamber 20 and thus, the inside of the pump chamber 20 becomes a negative pressure. Therefore, fluid is sucked into the pump chamber 20 through the suction pipe 21 and is discharged from the discharge pipe 22.

### Gate Mark

Gate marks “G” are formed on the inclined part 612 of the first partition part 61. The gate mark “G” is formed at a time of insert molding by which the stator core 31 and the like are covered with the resin sealing member 60. In this embodiment, nine gate marks “G” are formed at equal intervals in the circumferential direction. As shown in FIG. 6, when viewed from one side “L1” in the motor axial line “L” direction, the gate mark “G” is formed at all positions between the adjacent divided cores 310. Further, as shown in FIG. 7, when viewed from one side “L1” in the motor axial line “L” direction, the gate mark “G” is formed in a first region “H” where the coil 35 is wound. In this embodiment, the gate mark “G” is formed in a second region “H1” on an inner side in the radial direction with respect to a center part “C” of the first region “H”.

### Molding of Resin Sealing Member

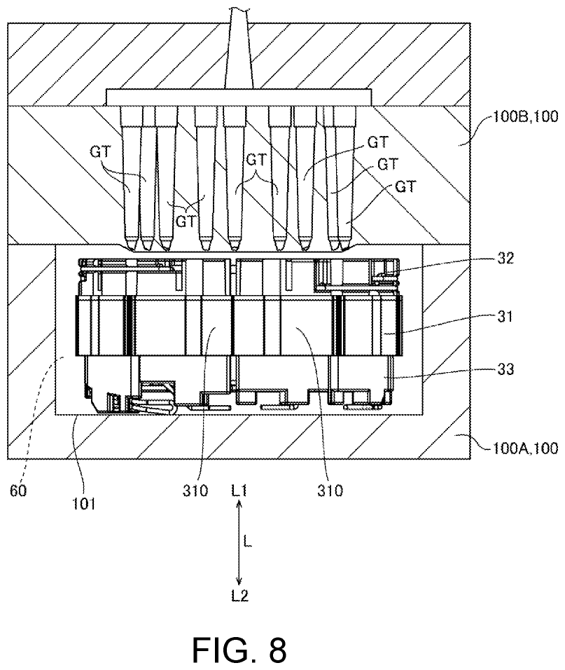

FIG. 8 is a schematic view showing a metal mold for performing insert molding of the resin sealing member. In FIG. 8, the connector terminals 75 and the like are omitted.

As shown in FIG. 8, when insert molding of the resin sealing member 60 is to be performed, the stator core 31 and the like are disposed in an inside of a metal mold 100A. In order to inject resin into the inside of the metal mold 100A, nine gates “GT” are provided in a metal mold 100B. The gate “GT” is, when viewed from one side “L1” in the motor axial line “L” direction, disposed between each of the adjacent divided cores 310. When resin is flowed into an inside of the metal mold 100A through the gates “GT”, the resin flows from a portion between the adjacent divided cores 310 toward the other side “L2” of the metal mold 100A and is accumulated from a bottom part 101 of the metal mold 100A. According to this structure, the resin flows smoothly and uniformly to the bottom part 101 from all positions between the respective adjacent divided cores 310 and thus, the stator core 31 and the like can be inhibited from moving from a predetermined position in the inside of the metal mold 100. As a result, the stator 3 can be obtained in which the stator core 31 and the like are covered by the resin sealing member 60 at an appropriate position. In this case, when the stator 3 is to be taken out from the metal mold 100, the first partition part 61 of the resin sealing member 60 is formed with the gate marks “G”.

### Operations and Effects

The stator 3 in this embodiment includes the stator core 31 which is structured of a plurality of the divided cores 310 disposed in a ring shape and the resin sealing member 60 which covers the stator core 31. The resin sealing member 60 is provided with the first partition part 61 which covers the stator core 31 from one side “L1” in the center axial line of the stator core 31 and is formed with the gate marks “G”. The gate mark “G” is, when viewed in the axial line direction of the center axial line, formed at all positions between the adjacent divided cores 310. Therefore, when the stator core 31 is arranged in an inside of the metal mold 100 and the stator core 31 is to be covered by the resin sealing member 60, resin uniformly flows into the inside of the metal mold 100 between the adjacent divided cores 310. In this case, the resin flows toward the other side “L2” of the metal mold 100A between the divided cores 310 and is accumulated from the bottom part 101 of the metal mold 100A. Therefore, the resin flows smoothly and uniformly to the bottom part 101 through all portions between the adjacent divided cores 310 and thus, the stator core 31 can be inhibited from moving from a predetermined position in the inside of the metal mold 100. As a result, the stator 3 can be obtained in which the stator core 31 is covered at an appropriate position by the resin sealing member 60.

In this embodiment, the stator 3 includes the coil 35 wound around the divided core 310. The divided core 310 is provided with the outer side arc part 311 formed in an arc shape and the salient pole part 312 which is protruded from the outer side arc part 311 toward an inner side in the radial direction of the stator core 31. The coil 35 is wound around the salient pole part 312. The gate mark “G” is, when viewed in the axial line direction, in the radial direction, formed in the first region “H” where the coil 35 is wound around. In addition, when viewed in the axial line direction, the gate mark “G” is, in the first region “H”, formed in the second region “H1” on an inner side in the radial direction with respect to the center part “C” of the first region “H”. Therefore, when the stator core 31 is to be covered by the resin sealing member 60, the stator core 31 can be further inhibited from moving from a predetermined position in the inside of the metal mold 100. As a result, the stator 3 can be obtained in which the stator core 31 is covered at a further appropriate position with respect to the resin sealing member 60.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A stator comprising:
a stator core comprised of a plurality of divided cores which are disposed in a ring shape; and
a resin sealing member which covers the stator core;
wherein the resin sealing member comprises a first partition part which covers the stator core from one side in an axial line direction along a center axial line of the stator core, the first partition part being formed with a gate mark; and
the gate mark is formed at all positions between the divided cores adjacent to each other when viewed from the one side in the axial line direction.

2. The stator according to claim 1, further comprising a coil which is wound around the divided core,
wherein the divided core comprises:
an outer side arc part which is formed in an arc shape; and
a salient pole part which is protruded from the outer side arc part toward an inner side in a radial direction of the stator core,
the coil is wound around the salient pole part, and
the gate mark is formed in a first region in the radial direction where the coil is wound when viewed from the one side in the axial line direction.

3. The stator according to claim 2, wherein the gate mark is formed in a second region of the first region on an inner side in the radial direction with respect to a center part of the first region when viewed from the one side in the axial line direction.

4. A motor comprising:
the stator defined in claim 1; and
a rotor which is disposed on an inner side with respect to the stator core and is rotated around the center axial line.

5. A pump device comprising:
the motor defined in claim 4;
a case which covers the resin sealing member from the one side and forms a pump chamber between the resin sealing member and the case, and
an impeller which is disposed in the pump chamber and is rotated together with the rotor.
